(19) United States
(12) Patent Application Publication
(10) Pub. No.: US 2008/0255326 A1
(43) Pub. Date: Oct. 16, 2008

(54) Process For Preparing Graft Polymers

(75) Inventors: Ralf Widmaier, Mannheim (DE); Ludger Wegmann, Ludwigshafen (DE); Antonietta Mauri, Albersweiler (DE); Klemens Mathauer, Taipei (TW); Wolfgang Jahnel, Bellheim (DE); Lidcay Herrera Taboada, Oostende (BE); Karin Neubecker, Frankenthal (DE); Alexander Khvorost, Laudenbach (DE)

Correspondence Address: CONNOLLY BOVE LODGE & HUTZ, LLP, P O BOX 2207, WILMINGTON, DE, 19899, US

(73) Assignee: BASF SE, Ludwigshafen (DE)

(21) Appl. No.: 12/090,961

(22) PCT Filed: Oct. 25, 2006
(86) PCT No.: PCT/EP2006/067745

§ 371 Date: Apr. 21, 2008

(30) Foreign Application Priority Data
Nov. 4, 2005 (DE) 10 2005 053 064.8

(51) Int. Cl. C08F 2/04

(52) U.S. Cl. 526/79

(57) ABSTRACT

Processes for preparing graft polymers and their use for inhibiting gas hydrates

The present invention relates to processes for preparing graft polymers by addition-polymerizing
A) 10% to 95% by weight of graft monomers A), comprising, based on the total amount of the graft monomers A),
   a) 1% to 99% by weight of at least one vinyl ester. [monomers a)],
   b) 1% to 99% by weight of at least one N-vinyl lactam [monomers b)], and if appropriate
   c) 0 to 10% by weight of at least one further ethylenically unsaturated monomer [monomers c)], the amounts of monomers a) to c) adding up to 100% by weight,
      in the presence of
B) 5% to 90% by weight of at least one polyalkylene oxide B) composed of at least 3 units of a C2 to C4 alkylene oxide, the total amounts of graft monomers A) and polyalkylene oxide B) adding up to 100% by weight,
   wherein
i) ≧50% by weight of the total amount of polyalkylene oxide B) and ≦10% by weight of the total amount of graft monomers A) are charged to a reaction vessel, then
ii) any remainder of polyalkylene oxide B) and also ≧90% by weight of the total amount of graft monomers A) are metered into the reaction vessel under polymerization conditions, with
iii) the major amounts of monomers a) and of monomers b) being metered in parallel in step ii),
iv) the polymerization, takes place in the presence of ≧2% by weight, based on the sum of the total amounts of graft monomers A) and polyalkylene oxide B), of at least one aprotic organic solvent L), if appropriate a partial amount or the total amount of the solvent L) being introduced as an initial charge in the reaction vessel in step i) and the total amount or any remainder of the solvent L) being metered into the reaction vessel in step ii), and
v) the water content of the polymerization mixture present in the reaction vessel during the polymerization at any time being ≦2% by weight, based on the sum of the total amounts of graft monomers A) and polyalkylene oxide B) metered into the reaction vessel at that time.

The present invention likewise relates to the graft polymers obtainable by the process and to their use for inhibiting gas hydrates.

The starting point for the preparation and use of graft polymers is the following prior art:

EP-A 285 038 describes the use of graft polymers based on polyalkylene oxides, N-vinyl-2-pyrrolidone, and vinyl esters as graying inhibitors (antiredeposition agents) in the laundering of textile ware. The preferred preparation of the graft polymers takes place there in bulk (without solvent); alternatively it may take place in water, alcohols, glycols or glycol ethers, and mixtures thereof.

WO 00/18375 discloses the use of water-soluble or water-dispersible, polyether-containing polymers as coating materials, binders and/or film-forming excipients in pharmaceutical administration forms. Employed for those purposes are graft polymers based on polyethers and vinyl esters and also, optionally, N-vinyl lactams. The graft polymers are prepared there in bulk, but also in water, alcohols, glycols or glycol ethers and also mixtures thereof. In the examples the graft polymerization is carried out in methanol.

DE-A 19935063 discloses the use of graft polymers for inhibiting gas hydrates. In that case the graft polymers are based preferably on a hydrophilic polymer framework with at least one heteroatom in the main polymer chain, polyalkylene glycols for example. Units used for grafting on are N-vinyl lactams and, optionally, vinyl esters. The grafting reactions take place preferably in bulk or in solution, in water and/or methanol for example.

WO 02/18526 as well discloses the use of graft polymers as graying inhibitors when laundering and aftertreating textile ware. Graft bases employed are, for example, polyalkylene oxides, and graft monomers employed are vinyl esters and N-vinyl lactams. In the examples the graft polymers are prepared by introducing polyethylene glycol as an initial charge and metering in a vinyl acetate/N-vinylcaprolactam mixture in parallel with a free-radical initiator/ethyl acetate mixture under polymerization conditions. In order that the viscosity does not rise too sharply the reaction mixture is admixed during the polymerization reaction with water (graft polymers 1 and 2). In contrast, during the preparation of graft polymers 3, 4, and 5, vinyl acetate and N-vinylcaprolactam are added sequentially.

Disadvantages of the graft polymers of the prior art are that aqueous solutions of these graft polymers with a graft polymer content ≧40% by weight are strongly colored, are frequently turbid, and, moreover, are also highly viscous.

It was an object of the present invention to provide a process for preparing graft polymers based on polyalkylene oxides and the graft monomers vinyl esters and vinyl lactams that yields graft polymers having improved properties.

Surprisingly this object has been achieved by means of the process defined at the outset.

The graft polymers are obtainable by polymerizing graft monomers A) in the presence of at least one polyalkylene oxide B). The reaction, accordingly, is a graft addition polymerization in which the graft monomers A) are grafted onto at least one polyalkylene oxide B).

The fraction of the graft monomers A) is 10% to 95%, preferably 20% to 75%, and with particular preference 25% to 60% by weight, based in each case on the total amount of graft monomers A) and polyalkylene oxides B). Correspondingly the fraction of the polyalkylene oxides B) is 5% to 90%, preferably 25% to 80%, and with particular preference 40% to 75% by weight.

The graft monomers A) comprise, based on the total amount of the graft monomers A),
a) 1% to 99%, preferably 10% to 70%, and in particular 15% to 55% by weight of at least one monomer a),
b) 1% to 99%, preferably 30% to 90%, and in particular 45% to 85% by weight of at least one monomer b), and
c) 0 to 10%, preferably 0 to 5%, and with particular preference 0 to 2% by weight of at least one further monomer, c), which is different than the monomers a) and b) and is ethylenically unsaturated.

Examples of suitable vinyl esters a) include vinyl esters of saturated carboxylic acids having 1 to 20, especially 1 to 6, carbon atoms. Examples are vinyl acetate, vinyl propionate, vinyl butanoate, vinyl hexanoate and/or vinyl octanoate. It is preferred to use vinyl acetate and vinyl propionate. Particular preference is given to using vinyl acetate. In accordance with the invention it is possible to use one vinyl ester alone or a mixture of two or more vinyl esters.

Suitable N-vinyl lactams b) are N-vinyl lactams having 4 to 13 carbon atoms in the lactam ring. Examples are N-vinyl-2-pyrrolidone, N-vinylcaprolactam, N-vinylvalerolactam, N-vinyllaurolactam, N-vinyl-2-piperidone, N-vinyl-2-pyridone, N-vinyl-3-methyl-2-pyrrolidone, N-vinyl-4-methyl-2-pyrrolidone and/or N-vinyl-5-methyl-2-pyrrolidone. It is preferred to use N-vinyl-2-pyrrolidone, N-vinylcaprolactam and/or N-vinyl-2-piperidone, and particularly preferred to use N-vinylcaprolactam. In accordance with the invention it is possible to use one N-vinyl lactam alone or a mixture of two or more N-vinyl lactams.

Examples of suitable copolymerizable monomers c) are vinylcarboxamides such as N-vinylformamide, N-vinyl-N-methylformamide, N-vinylacetamide, N-vinyl-N-methylacetamide, N-vinyl-N-methylpropionamide, and N-vinylpropionamide. It is preferred to use N-vinylformamide and/or N-vinyl-N-methylacetamide. The copolymerized monomer units of N-vinylformamide and/or N-vinyl-N-methylacetamide may be partly or fully hydrolyzed.

Suitable comonomers c) are also monoethylenically unsaturated monocarboxylic and dicarboxylic acids or their anhydrides having 3 to 6 carbon atoms, such as acrylic acid, methacrylic acid, crotonic acid, maleic acid or anhydride, fumaric acid, itaconic acid or anhydride, and citraconic acid or anhydride.

Further suitable monomers c) are the amides, esters, and nitriles of the aforementioned monoethylenically unsaturated C3 to C6 carboxylic acids, such as, for example, the amides acrylamide, methacrylamide, and also N-alkyl- and N,N-dialkylamides having alkyl radicals of 1 to 6 carbon atoms, such as N-methylacrylamide, N,N-dimethylacrylamide, N-methylmethacrylamide, N,N-dimethylmethacrylamide, N-ethylacrylamide, N-propylacrylamide, tert-butylacrylamide and tert-butylmethacrylamide, and also the basic (meth)acrylamides, such as 2-N,N-dimethylaminoethylacrylamide, 2-N,N-dimethylaminoethylmethacrylamide, 2-N,N-diethylaminoethylacrylamide, 2-N, N-diethylaminoethylmethacrylamide, 3-N,N-dimethylaminopropylacrylamide, 3-N,N-diethylaminopropylacrylamide, 3-N,N-dimethylaminopropylmethacrylamide and 3-N,N-diethylaminopropylmethacrylamide.

Other suitable monomers c) are the esters of monoethylenically unsaturated carboxylic acids with C1 to C6 alcohols, such as methyl acrylate, methyl methacrylate, ethyl acrylate, and ethyl methacrylate, or with glycols or polyglycols, in each case only one OH group in the glycols and polyglycols being esterified with an ethylenically unsaturated carboxylic acid, such as hydroxyethyl acrylate, hydroxyethyl methacrylate, hydroxypropyl acrylates, hydroxybutyl acrylates, hydroxypropyl methacrylates, hydroxybutyl methacrylates, and also the (meth)acrylic monoesters of polyalkylene glycols with a molar weight of 200 to 10 000. Of further suitability are the esters of the aforementioned ethylenically unsaturated carboxylic acids with pyrrolidone derivatives, such as, for example, 2-(N-pyrrolidone)ethyl acrylate or 2-(N-pyrrolidone)ethyl methacrylate, and with amino alcohols, such as 2-N,N-dimethylaminoethyl acrylate, 2-N,N-dimethylaminoethyl methacrylate, 2-N,N-diethylaminoethyl acrylate, 2-N,N-diethylaminoethyl methacrylate, 3-N,N-dimethylaminopropyl acrylate, 3-N,N-dimethylaminopropyl methacrylate, 3-N,N-diethylaminopropyl acrylate, 3-N,N-diethylaminopropyl methacrylate, 4-N,N-dimethylaminobutyl acrylate, 4-N,N-diethylaminobutyl acrylate, 5-N,N-dimethylaminopentyl acrylate, dimethylaminoneopentyl methacrylate and 6-N,N-dimethylaminohexyl acrylate. The basic (meth)acrylates and (meth)acrylamides are used in the form of the free bases, of the salts with mineral acids, such as hydrochloric acid, sulfuric acid, and nitric acid, or in quaternized form. Examples of suitable quaternizing agents include dimethyl sulfate, methyl chloride, ethyl chloride, benzyl chloride or diethyl sulfate.

Examples of nitriles of the aforementioned ethylenically unsaturated carboxylic acid are acrylonitrile and methacrylonitrile.

Additionally suitable as monomers c) are N-vinyl imidazole and also substituted N-vinyl imidazoles, such as N-vinyl-2-methylimidazole, N-vinyl-4-methylimidazole, N-vinyl-5-methylimidazole, and N-vinyl-2-ethylimidazole, N-vinyl imidazolines, such as N-vinyl imidazoline, N-vinyl-2-methylimidazoline, and N-vinyl-2-ethylimidazoline, and also N-vinyl imidazolidinones, such as N-vinyl-2-imidazolidinone and, N-vinyl-4-methyl-2-imidazolidinone. N-Vinyl imidazoles, N-vinyl imidazolines, and N-vinyl imidazolidinones are used not only in the form of the free bases but also in a form neutralized with mineral acids or in quaternized form, the quaternization being performed preferably using dimethyl sulfate, diethyl sulfate, benzyl chloride, methyl chloride or ethyl chloride.

Finally, monomers suitable as monomers c) include those comprising sulfo groups, such as vinylsulfonic acid, allylsulfonic acid, methallylsulfonic acid, styrenesulfonic acid, 3-sulfopropyl acrylate, 3-sulfopropyl methacrylate, and 2-acrylamido-2-methylpropanesulfonic acid. The compounds containing acid groups can be used in the form of the free acids, the ammonium salts or the alkali metal and alkaline earth metal salts for the graft polymerization.

Monomers c) may also be monomers having a crosslinking action, such as, for example, methylenebisacrylamide, esters of acrylic acid and methacrylic acid with polyhydric alcohols, examples being glycol diacrylate, glycerol triacrylate, glycol dimethacrylate, and glycerol trimethacrylate, and also polyols, such as pentaerythritol and glucose, which are esterified at least doubly with acrylic acid or methacrylic acid. Further suitable crosslinkers are divinylbenzene, divinyldioxane, N,N-divinyl-2-imidazolidinone, pentaerythritol triallyl ether, and pentaallylsucrose. Preferred crosslinking monomers c) are water-soluble monomers, such as glycol diacrylate or glycol diacrylates of polyethylene glycols with a molecular weight (numerical average) of 300 to 10 000.

It will be appreciated that mixtures of two or more monomers c) can also be used.

Among the monomers c) N-vinyl imidazole, acrylic acid, methacrylic acid, methacrylamide, N,N-dimethylacrylamide, N-methylmethacrylamide, tert-butylacrylamide, tert-butylmethacrylamide, dimethylaminoethylmethacrylamide, hydroxyethyl acrylate, 2-(N-pyrrolidone)ethyl acrylate, 2-(N-pyrrolidone)ethyl methacrylate, and 2-acrylamido-2-methylpropanesulfonic acid are preferably employed. Advantageously in accordance with the invention, however, no monomers c) are employed.

In accordance with the invention the graft monomers A) are addition-polymerized in the presence of at least one polyalkylene oxide B) which is composed of at least 3 units of a C2 to C4 alkylene oxide. Polyalkylene oxides B) of this kind are known to the skilled worker.

The polyalkylene oxides B) may be homopolymers and copolymers of C2 to C4 alkylene oxides. They are prepared by, for example, homopolymerizing or copolymerizing C2 to C4 alkylene oxides, such as, in particular, ethylene oxide, propylene oxide, n-butylene oxide and/or isobutylene oxide. The copolymers may be either random copolymers, if mixtures of at least two alkylene oxides are polymerized, or block copolymers, if first one alkylene oxide, ethylene oxide for example, is polymerized and then another alkylene oxide is polymerized, propylene oxide for example. The block copolymers may be assigned for example to type AB, ABA or BAB, A denoting for example a polyethylene oxide block and B a polypropylene oxide block. These copolymers may if appropriate additionally comprise n-butylene oxide and/or isobutylene oxide as well in copolymerized form.

The polyalkylene oxides B) comprise at least 3 alkylene oxide units in the molecule. The polyalkylene oxides B) may, however, comprise up to 50 000 alkylene oxide units in the molecule, for example. Suitable polyalkylene oxides B) are preferably those having 5 to 1000 alkylene oxide units in the molecule.

Preference is given to polyalkylene oxides B) having a number-average molecular weight of ≧200 and ≦50 000 g/mol and in particular ≧300 and ≦35 000 g/mol.

Polyalkylene oxides B) employed advantageously are the homopolymers of ethylene oxide or propylene oxide and the block copolymers of ethylene oxide and propylene oxide, and random copolymers of ethylene oxide and propylene oxide obtainable by copolymerizing a gas mixture of ethylene oxide and propylene oxide.

Particular preference is given to using homopolymers of ethylene oxide (i.e., polyethylene glycols), especially those having a number-average molecular weight of 600 to 10 000 g/mol, as polyalkylene oxide B).

For the purposes of the present invention a polyalkylene oxide B) is also to comprehend adducts of C2 to C4 alkylene oxides with alcohols, carboxylic acids, phenols, and amines. These adducts are obtained by reacting the C2 to C4 alkylene oxides with the corresponding alcohols, carboxylic acids, phenols, and amines. Alcohols suitable for reaction with the alkylene oxides have for example 1 to 30 carbon atoms, such as methanol, ethanol, n-propanol, isopropanol, n-butanol, n-octanol, 2-ethylhexanol, decanol, dodecanol, palmityl alcohol, cetyl alcohol, and stearyl alcohol. Of particular industrial interest are the alcohols obtainable by oxo synthesis, examples being C10 alcohols, C13 oxo-process alcohols, or naturally occurring alcohols such as C10/C18 tallow fatty alcohols. Besides the monohydric alcohols stated it is also possible of course to use dihydric and polyhydric alcohols, such as glycol, glycerol, erythritol, pentaerythritol, and sorbitol. The alcohols are typically reacted in a molar ratio of 1:5 to 1:1000, preferably 1:10 to 1:200, with at least one C2 to C4 alkylene oxide.

Carboxylic acids suitable for reaction with the alkylene oxides are, in particular, fatty acids, preferably those having 8 to 25 carbon atoms in the molecule. Examples are lauric acid, myristic acid, stearic acid, palmitic acid, coconut fatty acid, tallow fatty acid, and oleic acid.

Phenols suitable for reaction with the alkylene oxides are, for example, C1 to C12 alkylphenols, such as n-decylphenols, n-octylphenols, isobutylphenols, and methylphenols.

Amines suitable for reaction with the alkylene oxides are, for example, secondary C2 to C30 amines, such as, for example, di-n-butylamine, di-n-octylamine, dimethylamine, and distearylamine. The molar ratio of amine to at least one alkylene oxide is generally 1:5 to 1:1000 and is situated preferably in the range from 1:10 to 1:200.

For the adducts of alkylene oxides with alcohols, phenols, acids or amines it is possible to addition-react the aforementioned compounds with the alkylene oxides in the form of a gas mixture, or else the reaction is carried out first with ethylene oxide and subsequently with propylene oxide. It is also possible to subject first propylene oxide and then ethylene oxide to addition reaction with the stated compounds. Apart from ethylene oxide and propylene oxide, it is possible in each case, if appropriate, to react isobutylene oxide and/or n-butylene oxide as well. The sequential addition reaction of the alkylene oxides produces the corresponding block copolymers.

In certain cases, moreover, it may also be of advantage to cap the free OH groups of the alkoxylation products with an end group. End group capping is familiar to the skilled worker and can be done, for example, with an alkyl radical, to form an ether group. By way of example the alkoxylation products can be reacted with alkylating agents such as dimethyl sulfate. The terminal OH groups may where appropriate also be esterified by reaction with carboxylic acids, acetic acid or stearic acid for example.

In accordance with the invention it is also possible to use a mixture of two or more polyalkylene oxides B).

One preferred embodiment uses
20% to 75% by weight of graft monomers A), comprising
a) 10% to 70% by weight of monomers a) and
b) 30% to 90% by weight of monomers b),
   and
25 to 80% by weight of polyalkylene oxide B).

Particular preference is given to using
25% to 60% by weight of graft monomers A), comprising
a) 15% to 55% by weight of monomers a) and
b) 45% to 85% by weight of monomers b),
   and
40% to 75% by weight of polyalkylene oxide B).

It is essential to the process that the polymerization reaction take place in the presence of ≧2% by weight, based on the sum of the total amounts of graft monomers A) and polyalkylene oxide B), of at least one aprotic organic solvent L). Suitable aprotic organic solvents L) are all organic solvents which under the polymerization conditions contain no ionizable proton in the molecule and/or have a pKa value which is greater than that of water. Examples of such solvents L) are aromatic hydrocarbons, such as toluene, o-, m-, and p-xylene, and isomer mixtures, and also ethylbenzene, linear or cyclic aliphatic hydrocarbons, such as pentane, hexane, heptane, octane, nonane, dodecane, cyclohexane, cyclooctane, methylcyclohexane, and also mixtures of the aforementioned hydrocarbons and benzine fractions which comprise no polymerizable monomers; aliphatic or aromatic halogenated hydrocarbons, such as chloroform, carbon tetrachloride, hexachloroethane, dichloroethane, tetrachloroethane and chlorobenzene, and also liquid C1 or C2 hydrofluorochlorocarbons; aliphatic C2 to C5 nitriles, such as acetonitrile, propionitrile, butyronitrile or valeronitrile, linear or cyclic aliphatic C3 to C7 ketones, such as acetone, methyl ethyl ketone, methyl isobutyl ketone, 2- and 3-hexanone, 2-, 3- and 4-heptanone, cyclopentanone, and cyclohexanone, linear or cyclic aliphatic ethers, such as diisopropyl ether, 1,3- or 1,4-dioxane, tetrahydrofuran or ethylene glycol dimethyl ether, carbonates, such as diethyl carbonate, and also esters of aliphatic C1 to C5 carboxylic acids or aromatic carboxylic acids with aliphatic C1 to C5 alcohols, such as ethyl formate, n-propyl formate, isopropyl formate, n-butyl formate, isobutyl formate, tert-butyl formate, amyl formate, methyl acetate, ethyl acetate, n-propyl acetate, isopropyl acetate, n-butyl acetate, isobutyl acetate, tert-butyl acetate, amyl acetate, methyl propionate, ethyl propionate, n-propyl propionate, isopropyl propionate, n-butyl propionate, isobutyl propionate, tert-butyl propionate, amyl propionate, methyl butyrate, ethyl butyrate, n-propyl butyrate, isopropyl butyrate, n-butyl butyrate, isobutyl butyrate, tert-butyl butyrate, amyl butyrate, methyl valerate, ethyl valerate, n-propyl valerate, isopropyl valerate, n-butyl valerate, isobutyl valerate, tert-butyl valerate, amyl valerate, methyl benzoate or ethyl benzoate, and also lactones, such as butyrolactone, valerolactone or caprolactone.

In accordance with the invention the solvents L) may be present in the reaction mixture either in dissolved form (i.e., homogeneous form) or else in emulsified form (i.e., inhomogeneous form). Preferably, however, solvents L) selected are those in which the particular free-radical initiators used dissolve readily. Solvents L) employed in particular are those in which not only the free-radical initiators but also the graft monomers A) dissolve readily. Particular advantage attaches to selecting solvents L) in which not only the free-radical initiators and the graft monomers A) but also the polyalkylene oxides B) as well are able to dissolve. Advantageously, however, selection is also made of those solvents L) in which not only the free-radical initiators and the graft monomers A) but also the polyalkylene oxides B) and, additionally, the graft polymers formed from them dissolve, or, respectively, those which are able themselves to dissolve in the components A) and B) and also in the graft polymers formed, i.e., in the reaction mixture obtained. Particular preference is, given to selecting solvents L) which additionally can be separated off in a simple manner from the resultant graft polymer mixture, such as by inert gas stripping and/or distillation, including steam distillation. Preferred examples thereof are esters of aliphatic C1 to C5 carboxylic acids or aromatic carboxylic acids with aliphatic C1 to C5 alcohols, such as ethyl formate, n-propyl formate, isopropyl formate, n-butyl formate, isobutyl formate, tert-butyl formate, amyl formate, methyl acetate, ethyl acetate, n-propyl acetate, isopropyl acetate, n-butyl acetate, isobutyl acetate, tert-butyl acetate, amyl acetate, methyl propionate, ethyl propionate, n-propyl propionate, isopropyl propionate, n-butyl propionate, isobutyl propionate, tert-butyl propionate, amyl propionate, methyl butyrate, ethyl butyrate, n-propyl butyrate, isopropyl butyrate, linear or cyclic aliphatic ethers, such as diisopropyl ether, 1,3- or 1,4-dioxane, tetrahydrofuran or ethylene glycol dimethyl ether, methyl glycol acetate, diethyl carbonate, linear or cyclic aliphatic C3 to C7 ketones, such as acetone, methyl ethyl ketone, methyl isobutyl ketone, 2- or 3-hexanone, 2-, 3- or 4-heptanone, cyclopentanone, or cyclohexanone. Particularly preferred solvents are the aforementioned esters of aliphatic C1 to C5 carboxylic acids or aromatic carboxylic acids with aliphatic C1 to C5 alcohols, but particularly ethyl acetate and ethyl butyrate. It is favorable if the solvent L) has a boiling point under atmospheric pressure (1 atm=1.013 bar) ≦140° C., frequently ≦125° C., and in particular ≦100° C.

It is of course also possible to use a mixture of two or more solvents L).

The total amount of organic solvent L) is ≧2% or ≧5% by weight, preferably ≧10% by weight, and with particular preference ≧15% by weight, based on the sum of the total amounts of graft monomers A) and polyalkylene oxide B). It has proven advantageous if the total amount of organic solvent L), based on the sum of the total amounts of graft monomers A) and polyalkylene oxide B), does not exceed a fraction of 50% by weight, in particular of 35% by weight. Based on the sum of the total amounts of graft monomers A) and polyalkylene oxide B) the amount of solvent is preferably ≧10% and ≦35% by weight.

Nature and amount of the solvent L) are preferably selected such that L) is able to form a homogeneous phase at room temperature (20 to 25° C.) at least with the total amount of the free-radical initiator and also, preferably, with the graft monomers A) comprised in the polymerization mixture.

For the preparation of the graft polymers the graft monomers A) are addition-polymerized in the presence of polyalkylene oxides B), preferably free-radically. For this purpose free-radical initiators in particular are employed.

Suitable free-radical initiators (radical-forming initiators) are preferably all compounds which at the particular polymerization temperature selected have a half-life of 4 hours or less. If the polymerization is commenced at a relatively low temperature and completed at a higher temperature then it is advantageous to operate with at least two free-radical initiators that decompose at different temperatures—that is, first to use a free-radical initiator which decomposes at a relatively low temperature, for the start of the polymerization, and then a radical initiator that decomposes at a higher temperature, to complete the main polymerization. In principle it is possible to use water-soluble and oil-soluble free-radical initiators, or mixtures of water-soluble and oil-soluble free-radical initiators.

Water-soluble free-radical initiators are generally understood to be all those which are typically used in the context of free-radically initiated aqueous emulsion polymerization, whereas oil-soluble free-radical initiators are understood to be all those which the skilled worker typically employs for free-radically initiated solution polymerization. For the purposes of this specification water-soluble free-radical initiators shall be taken to be all those which have a solubility ≧1% by weight in deionized water at 20° C. under atmospheric pressure, while oil-soluble free-radical initiators will be taken to be all those which have a solubility ≦1% by weight under the aforementioned conditions. Water-soluble free-radical initiators under aforementioned conditions frequently have a water solubility ≧2%, ≧5% or ≧10% by weight, whereas oil-soluble free-radical initiators frequently have a water solubility ≦0.9%, ≦0.8%, ≦0.7%, ≦0.6%, ≦0.5%, ≦0.4%, ≦0.3%, ≦0.2% or ≦0.1% by weight.

The water-soluble free-radical initiators may for example be either peroxides or azo compounds. Redox initiator systems as well, of course, are suitable. Peroxides which can be used include, in principle, inorganic peroxides, such as hydrogen peroxide or peroxodisulfates, such as the mono- or di-alkali metal or -ammonium salts of peroxodisulfuric acid, such as their mono- and di-sodium, -potassium, or -ammonium salts, or organic peroxides, such as alkyl hydroperoxides, examples being tert-butyl, p-menthyl, and cumyl hydroperoxide. An azo compound employed is, importantly, 2,2′-azobis(amidinopropyl) dihydrochloride (AIBA, or V-50 from Wako Chemicals). Suitable oxidants for redox initiator systems are essentially the abovementioned peroxides. Corresponding reductants which can be used include compounds of sulfur with a low oxidation state, such as alkali metal sulfites, examples being potassium and/or sodium sulfite, alkali metal hydrogen sulfites, examples being potassium and/or sodium hydrogen sulfite, alkali metabisulfites, examples being potassium and/or sodium metabisulfite, formaldehyde-sulfoxylates, examples being potassium and/or sodium formaldehyde sulfoxylate, alkali metal salts, especially potassium and/or sodium salts, of aliphatic sulfinic acids, and alkali metal hydrogen sulfides, such as potassium and/or sodium hydrogen sulfide, salts of polyvalent metals, such as iron(II) sulfate, iron(II) ammonium sulfate, iron(II) phosphate, ene diols, such as dihydroxymaleic acid, benzoin and/or ascorbic acid, and also reducing saccharides, such as sorbose, glucose, fructose and/or dihydroxyacetone.

As oil-soluble free-radical initiators mention may be made by way of example of dialkyl and diaryl peroxides, such as di-tert-amyl peroxide, dicumyl peroxide, bis(tert-butylperoxyisopropyl)benzene, 2,5-bis(tert-butylperoxy)-2,5-dimethylhexane, tert-butylcumene peroxide, 2,5-bis(tert-butylperoxy)-2,5-dimethyl-3-hexene, 1,1-bis(tert-butylperoxy)-3,3,5-trimethylcyclohexane, 1,1-bis(tert-butylperoxy)cyclohexane, 2,2-bis(tert-butylperoxy)butane or di-tert-butyl peroxide, aliphatic and aromatic peroxy esters, such as cumyl peroxyneodecanoate, 2,4,4-trimethylpent-2-yl peroxyneodecanoate, tert-amyl peroxyneodecanoate, tert-butyl peroxyneodecanoate, tert-amyl peroxypivalate, tert-butyl peroxypivalate, tert-amyl peroxy-2-ethylhexanoate, tert-butyl peroxy-2-ethylhexanoate, tert-butyl peroxydiethylacetate, 1,4-bis(tert-butylperoxy)cyclohexane, tert-butyl peroxyisobutanoate, tert-butyl peroxy-3,5,5-trimethylhexanoate, tert-butyl peroxyacetate, tert-amyl peroxybenzoate or tert-butyl peroxybenzoate, dialkanoyl and dibenzoyl peroxides, such as diisobutanoyl peroxide, bis(3,5,5-trimethylhexanoyl) peroxide, dilauroyl peroxide, didecanoyl peroxide, 2,5-bis(2-ethylhexanoylperoxy)-2,5-dimethylhexane or dibenzoyl peroxide, and also peroxy carbonates, such as bis(4-tert-butylcyclohexyl) peroxydicarbonate, bis(2-ethylhexyl) peroxydicarbonate, di-tert-butyl peroxydicarbonate, diacetyl peroxydicarbonate, dimyristyl peroxydicarbonate, tert-butyl peroxyisopropyl carbonate or tert-butyl peroxy-2-ethylhexyl carbonate. Readily oil-soluble azo initiators used include, for example, 2,2′-azobis(isobutyronitrile), 2,2′-azobis(2,4-dimethylvaleronitrile) or 4,4′-azobis(4-cyanopentanoic acid).

As oil-soluble free-radical initiator it is preferred to use a compound selected from the group comprising tert-butyl peroxy-2-ethylhexanoate (Trigonox® 21; Trigonox® brand from Akzo Nobel), tert-amyl peroxy-2-ethylhexanoate (Trigonox® 121), tert-butyl peroxybenzoate (Trigonox® C), tert-amyl peroxybenzoate, tert-butyl peroxyacetate (Trigonox® F), tert-butyl peroxy-3,5,5-trimethylhexanoate (Trigonox® 42 S), tert-butyl peroxyisobutanoate, tert-butyl peroxydiethylacetate (Trigonox® 27), tert-butyl peroxypivalate (Trigonox® 25), tert-butyl peroxyisopropyl carbonate (Trigonox® BPIC), 2,5-dimethyl-2,5-di(tert-butylperoxy)hexane (Trigonox® 101), di-tert-butyl peroxide (Trigonox® B), cumyl hydroperoxide (Trigonox® K), and tert-butyl peroxy-2-ethylhexyl carbonate (Trigonox® 117). It is of course also possible to use mixtures of aforementioned oil-soluble free-radical initiators.

In accordance with the invention it is preferred to use oil-soluble free-radical initiators.

If, in addition to the stated free-radical initiators, salts or complexes of heavy metals are used, such as salts of copper, of cobalt, of manganese, of iron, of vanadium, of nickel, and of chromium, or organic compounds are used, such as benzoin, dimethylaniline or ascorbic acid, then the half-lives of the free-radical initiators indicated may be markedly reduced.

Based on the total amount of monomers a) to c) used in the polymerization, it is usual to use 0.01% to 10% by weight, preferably 0.02% to 5% by weight, of a free-radical initiator or of a mixture of two or more free-radical initiators. The above-mentioned heavy metals are used in the range from 0.1 to 100 parts per million (ppm), preferably 0.5 to 10 ppm, based on the total amount of monomers a) to c) employed.

Alternatively the graft polymerization of the graft monomers A) may be carried out by exposure to high-energy radiation, such as ultraviolet radiation, in the presence if appropriate of UV initiators. Polymerization under exposure to UV radiation is carried out using the sensitizers and/or photoinitiators that are typically suitable for that purpose. These are, for example, compounds such as benzoin and benzoin ethers, α-methylbenzoin or α-phenylbenzoin. Triplet sensitizers too, as they are called, such as benzyl diketals, can be used. Examples of UV radiation sources employed include not only high-energy UV lamps, such as carbon arc lamps, but also mercury vapor lamps or xenon lamps.

If appropriate it may be advantageous that the free-radical polymerization be carried out in the presence of free-radical chain regulators. Suitable such regulators are, for example, organic compounds comprising sulfur in bonded form. These include, for example, mercapto compounds, such as mercaptoefhanol, mercaptopropanol, mercaptobutanol, mercaptoacetic acid, mercaptopropionic acid, butyl mercaptan, and dodecyl mercaptan. Further free-radical chain regulators are familiar to the skilled worker. If the polymerization is carried out in the presence of free-radical chain regulators then frequently 0.01% to 10% by weight is used, based on the total amount of graft monomers a) to c). With advantage in accordance with the invention, however, no free-radical chain regulators are used.

Depending on the free-radical initiator used, the free-radically initiated polymerization takes place typically at temperatures in the range from 40 to 180° C., preferably from 50 to 150° C., and in particular from 60 to 110° C. As soon as the temperature in the polymerization reaction is above the boiling point of the organic solvent L) and/or of the graft monomers A), the polymerization is carried out advantageously under super-atmospheric pressure. Where the polymerization takes place by exposure to high-energy radiation, the polymerization reaction can also take place at lower temperatures, ≦40° C., ≦20° C. or ≦10° C. for example.

The graft polymers can be prepared in the typical polymerization apparatus. For this purpose use is made, for example, of glass flasks (laboratory) or stirred tanks (industrial scale) which are equipped with an anchor stirrer, blade stirrer, impeller stirrer, cross-arm stirrer, or MIG or multistage pulse countercurrent stirrer. Particularly in the case of polymerization in the presence of only small amounts of solvent L) it may also be advantageous to carry out the polymerization in typical kneading reactors with one or two shafts (co- or counter-rotating), such as those from the company List or Buss SMS, for example.

Essential to the process of the invention is that in step i) ≧50%, ≧80%, preferably ≧90% of the total amount and with particular preference the total amount, of polyalkylene oxide B) and ≦10%, ≦5% by weight of the total amount of graft monomers A) is included in the initial charge to the reaction vessel. With particular preference no graft monomers A) are included in the initial charge to the polymerization vessel. It is also possible to include partial or total amounts of free-radical initiators, UV initiators if appropriate, heavy metal compounds, free-radical chain regulators, solvents L) or other typical auxiliaries in the initial charge to the reaction vessel. With advantage the reaction vessel is rendered inert using an inert gas, such as nitrogen, carbon dioxide or argon, and the subsequent graft polymerization is carried out under an inert gas atmosphere. Rendering the vessel inert involves setting oxygen concentrations of ≦5%, preferably ≦1%, and with particular preference ≦0.1% by volume. Subsequently the polymerization conditions needed for the ensuing graft polymerization are set, such as temperature, pressure, etc., and/or the introduction of high-energy radiation is commenced. The conditions under which the polymerization can be started and/or maintained are known to the skilled worker or can be determined by him or her in a few preliminary tests; in particular they are dependent on the nature of the employed graft monomers A), polyalkylene oxides B), free-radical initiators, and/or high-energy radiation.

After the requisite polymerization conditions have been set, in step ii) any remainder of polyalkylene oxide B) and also any remainder of ≧90% by weight, but preferably the total amount, of graft monomers A) are metered into the reaction vessel under polymerization conditions. In step ii), however, any remainders or the total amounts of free-radical initiators, UV initiators if appropriate, heavy metal compounds, free-radical chain regulators, solvents L) or other typical auxiliaries are also metered into the reaction vessel. In this case the solvent L) is preferably metered in a mixture with the graft monomers A) and/or with the free-radical initiators. The metering times of the components are typically situated within a range ≧10 minutes and ≦10 hours and in particular are dependent on the batch size, the polymerization temperature, and the components selected. The procedure here is generally such that the graft monomers A) are metered in at the rate at which they are consumed; in other words, such that the amount of graft monomer is always sufficient not to interrupt the polymerization reaction, while on the other hand the amount of graft monomer in the reaction vessel is not too great, so as to prevent uncontrolled polymerization reaction (runaway reaction).

With particular advantage the polymerization conditions are selected such that at any time ≧10% of the total metering time of the monomers a), the amount of monomers a) in the polymerization mixture is ≦1%, preferably ≦0.5%, and with particular preference ≦0.3% by weight.

It is important that the major amounts, i.e., ≧50%, preferably ≧60%, and with particular preference ≧70%, by weight of the total amounts of monomers a) and monomers b) are metered in parallel in step ii). The metering of the monomers a) and of the monomers b) may take place discontinuously, in two or more portions, and also continuously, with constant or changing volume flows. Advantageously the metering of monomers a) and b) takes place continuously and with constant volume flows. In one preferred embodiment the metering of the monomers a) and b) may commence simultaneously. It is also possible, though, for the metering of the monomers a) to be commenced before the metering of the monomers b). Likewise it is also possible to commence metering of the monomers b) prior to the metering of the monomers a). The metering of the monomers c) used optionally is not critical and may in principle take place before, during or after the metering of the major amounts of monomers a) and monomers b).

Advantageously the metering of the monomers a) and b) in step ii) takes place such that the metering of the monomers a) and b) commences simultaneously, the metering of the monomers a) and b) takes place continuously and with constant volume flows, and the metering time of the monomers b) is greater than or equal to the metering time of the monomers a). Likewise advantageously the metering time of the monomers b) is greater than the metering time of the monomers a), the ratio of the metering times of the monomers b) to the metering times of the monomers a) being ≧1.1, preferably ≧1.3 or ≧1.5 but ≦2.0.

It is essential to the process that the water content of the polymerization mixture in the reaction vessel during the polymerization is at any time ≦2%, preferably ≦1%, and with particular preference ≦0.5% by weight, based on the sum of the total amounts of graft monomers A) and polyalkylene oxide B) metered into the reaction vessel at that time. One of the ways in which this is ensured is by the feedstock materials used having a water content ≦2%, preferably ≦1%, and with particular preference ≦0.5% by weight and not including any materials which can give off water under polymerization conditions.

In order to complete the polymerization reaction and to minimize the unreacted graft monomers A), the polymerization mixture is generally also afterreacted under polymerization conditions after the end of the metering of the graft monomers A). In this case it may be of advantage to supply further free-radical initiator or UV initiator.

Since the polymerization mixture after the end of the polymerization reaction, depending on the amount of solvent L) used, is frequently of very high viscosity, its viscosity can be reduced by the addition thereto of 10% to 100% by weight, based on the polymerization mixture, of water, a monohydric, dihydric or polyhydric alcohol and/or a corresponding monoalkoxy alcohol. The alcohols, monoalkoxy and/or otherwise, frequently exhibit a synergistic action in the context of inhibiting gas hydrates.

Particularly suitable monohydric, dihydric or polyhydric alcohols are the C1 to C8 alcohols, the C2 to C8 alkanediols, and also C3 to C10 triols or polyols. Examples of these are methanol, ethanol, n-propanol, isopropanol, n-butanol, sec-butanol, tert-butanol, n-pentanol, 2-pentanol, 3-pentanol, n-hexanol, 2-hexanol, 3-hexanol, 4-hexanol, n-heptanol, n-octanol, 2-ethylhexanol, 3-ethylhexanol or 4-ethylhexanol, and also ethylene glycol, propylene glycol, 1,3-propanediol, 1,2-butanediol, 1,3-butanediol, 1,4-butanediol, 1,6-hexanediol or 1,4-dimethylbutane-1,4-diol.

Monoalkoxy alcohols used are, in particular, the aforementioned C1 to C8 alcohols and C2 to C8 alkanediols and also C3 to C10 triols that are substituted by a C1 to C6 alkoxy group. Examples of these are methoxymethanol, 2-methoxyethanol, 2-methoxypropanol, 3-methoxypropanol, 2-methoxybutanol, 3-methoxybutanol, 4-methoxybutanol, 2-ethoxyethanol, 2-ethoxypropanol, 3-ethoxypropanol, 2-ethoxybutanol, 3-ethoxybutanol, 4-ethoxybutanol, 2-isopropoxyethanol, 2-isopropoxypropanol, 3-isopropoxypropanol, 2-isopropoxybutanol, 3-isopropoxybutanol, 4-isopropoxybutanol, 2-(n-propoxy)ethanol, 2-(n-propoxy)propanol, 3-(n-propoxy)propanol, 2-(n-propoxy)butanol, 3-(n-propoxy)butanol, 4-(n-propoxy)butanol, 2-(n-butoxy)ethanol, 2-(n-butoxy)propanol, 3-(n-butoxy)propanol, 2-(n-butoxy)butanol, 3-(n-butoxy)butanol, 4-(n-butoxy)butanol, 2-(sec-butoxy)ethanol, 2-(sec-butoxy)propanol, 3-(sec-butoxy)propanol, 2-(sec-butoxy)butanol, 3-(sec-butoxy)butanol, 4-(sec-butoxy)butanol, 2-(tert-butoxy)ethanol, 2-(tert-butoxy)propanol, 3-(tert-butoxy)propanol, 2-(tert-butoxy)butanol, 3-(tert-butoxy)butanol, 4-(tert-butoxy)butanol, (n-hexoxy)methanol, 2-(n-hexoxy)ethanol, 2-(n-hexoxy)propanol, 3-(n-hexoxy)propanol, 2-(n-hexoxy)butanol, 3-(n-hexoxy)butanol or 4-(n-hexoxy)butanol.

In general it is advantageous for the organic solvent L) to be separated off before, during and/or after the addition of water, alcohol and/or monoalkoxy alcohol, this separation being accomplished by means of distillation or stripping with inert gas or steam. The corresponding techniques for this purpose are familiar to the skilled worker. The result of these techniques is generally the corresponding graft polymer solutions. These solutions frequently have graft polymer contents in the range from 30% to 90% or 40% to 70% by weight. The replacement of the solvent L) by water, alcohol or monoalkoxy alcohol is frequently carried out up to a residual solvent L) content ≦10 000 ppm, ≦5000 ppm or even ≦1000 ppm.

Particularly in the form of their stable aqueous solutions, the graft polymers obtainable by the process of the invention are clear liquids which are colorless to pale yellowish in color and which for a given graft polymer content generally have a viscosity much lower than that of the corresponding products prepared in accordance with the prior art. The graft polymers of the invention, particularly in the form of their solutions with alcohols, including monoalkoxy alcohols, are suitable advantageously for inhibiting gas hydrates and generally have a better inhibitory action than the corresponding graft polymers prepared in accordance with the prior art. Moreover, the graft polymers obtainable by the process of the invention display good biodegradabilities in accordance with OECD 301 A (DOC Die-Away test).

The graft polymers of the invention can also be used as an additive to liquid laundry detergents. These liquid dispersions comprise liquid surfactants or even solid surfactants as a blend component, these surfactants being soluble or at least dispersible in the detergent formulation. The surfactant content of liquid laundry detergents is typically in the range from 15% to 50% by weight. Surfactants suitable for this purpose are the products which are also used in powder detergents, and also liquid polyalkylene oxides and/or polyalkoxylated compounds. If the graft polymers are not directly miscible with the remaining ingredients of the liquid detergent, a homogeneous mixture can be prepared by using a small amount of solubilizers, such as water or a water-miscible organic solvent, such as isopropanol, methanol, ethanol, glycol, diethylene glycol or triethylene glycol, for example.

The graft polymers of the invention are additionally suitable as an adjuvant when aftertreating textile ware, especially textile ware comprising synthetic fibers. For this purpose they are added to the final rinse bath of a washing-machine cycle, the addition being able to take place either together with a fabric softener typically employed at this point or else—if a softener is not wanted—on their own, instead of the softener. The amounts employed are 0.01 to 0.3 g/l of wash liquor. The use of the graft polymers in the final rinse bath of a washing-machine cycle has the advantage that in the subsequent wash cycle the laundry is soiled far less by detached dirt particles present in the wash liquor than without the addition of the graying inhibitor (antiredeposition agent) in the preceding wash.

A feature of the graft polymers of the invention is that not only is the graying effectively reduced but also the soil is effectively released.

It is significant, furthermore, that the graft polymers of the invention constitute outstanding dispersing assistants for organic or inorganic pigments in aqueous media.

The nonlimiting examples below are intended to illustrate the invention.

### EXAMPLES

The K values of the graft polymers were measured by the method of H. Fikentscher, Cellulosechemie 13 (1932) 58 to 64 and 71 to 74 in water at a temperature of 23° C. with a polymer concentration of 5% by weight.

The viscosities were determined using a Brookfield viscometer, Brookfield LV-DV II+, spindle 4, 60 rpm; temperature: 23° C.; polymer concentration (solids content): as indicated in examples. The unit is: [mPa*s].

The residual N-vinylcaprolactam contents were generally determined by means of gas chromatography (instrument: Hewlett Packard HP 5890, column: Chrompack CP-WAX 52 CB, detector: flame ionization detector).

### Preparation of the Graft Polymers

The polyethylene glycol used had a number-average molecular weight of approximately 6000 g/mol. Pluriol® E 6000 from BASF AG was used. Generally speaking, deionized water was used.

### Graft polymer P1

A polymerization pressure vessel was charged under nitrogen with 300 g of polyethylene glycol and 25 g of ethyl acetate and this initial charge was heated at 80° C. until all the polyethylene glycol had melted. Subsequently, with stirring, 24 mg of tert-butylperoxy-2-ethylhexanoate in solution in 0.42 g of ethyl acetate were added and the mixture obtained was stirred for 5 minutes. The feeds below were metered into the polymerization vessel at an internal temperature of 80° C., beginning simultaneously, with stirring, and continuously, with constant volume flow rates:
Feed I: monomer mixture consisting of 50 g of vinyl acetate and 150 g of N-vinylcaprolactam, metered in over the course of 6 hours, and
Feed II: 3.25 g of tert-butylperoxy-2-ethylhexanoate in solution in 62 g of ethyl acetate, metered in over the course of 6.5 hours.

After the end of feed II 1 g of tert-butylperoxy-2-ethylhexanoate in solution in 10 g of ethyl acetate was added and polymerization was continued at 80° C. for 1 hour. In the course of the polymerization the internal pressure rose slowly to around 1.5 bar (overpressure). Thereafter the ethyl acetate was, removed by distillation (temperature: 80 to 92° C., pressure: atmospheric pressure, time: approximately 1 hour). Residual amounts of ethyl acetate were removed by steam distillation (temperature: 92 to >100° C. internal temperature, steam pressure: 5 bar, time: approximately 1 hour; distillate volume: approximately 1000 ml). Subsequently a solids content of 47.8% by weight was set using deionized water. The solution obtained was slightly yellowish and water-clear. It had a viscosity of 2100 mPas. The viscosity of a 40% strength by weight aqueous solution was 370 mPas. The K value of the graft polymer was 26.4. The residual N-vinylcaprolactam content was <50 ppm.

### Graft Polymer P2

A polymerization pressure vessel was charged under nitrogen with 300 g of polyethylene glycol at atmospheric pressure and this initial charge was heated at 80° C. until all the polyethylene glycol had melted. Subsequently, with stirring, 70 mg of tert-butyl peroxy-2-ethylhexanoate in solution in 0.93 g of ethyl acetate were added and the mixture obtained was stirred for 5 minutes. The feeds below were metered into the polymerization vessel at an internal temperature of 80° C., beginning simultaneously, with stirring, and continuously, with constant volume flow rates:
Feed I: monomer mixture consisting of 50 g of vinyl acetate, 150 g of N-vinylcaprolactam, and 15 g of ethyl-acetate, metered in over the course of 6 hours
Feed II: 3.18 g of tert-butyl peroxy-2-ethylhexanoate in solution in 43.1 g of ethyl acetate, metered in over the course of 6.5 hours.

After the end of feed II 2 g of tert-butyl peroxy-2-ethylhexanoate in solution in 20 g of ethyl acetate were added and polymerization was continued at 80° C. for 1 hour. Thereafter the ethyl acetate was removed by distillation (temperature: 80 to 92° C., pressure: atmospheric pressure, time: approximately 1 hour). Residual amounts of ethyl acetate were removed by steam distillation (temperature: 92 to >100° C. internal temperature, steam pressure: 5 bar, time: approximately 1 hour; distillate volume: approximately 1000 ml). Subsequently a solids content of 48.1% by weight was set using deionized water. The solution obtained was slightly yellowish and water-clear. It had a viscosity of 2150 mPas. The viscosity of a 40% strength by weight aqueous solution was 380 mPas. The K value of the graft polymer was 26.1. The residual N-vinylcaprolactam content was <50 ppm.

### Graft Polymer C1

### Comparative Example 1

A polymerization pressure vessel was charged under nitrogen with 300 g of polyethylene glycol at atmospheric pressure and this initial charge was heated at 80° C. until all the polyethylene glycol had melted. Subsequently, with stirring, 70 mg of tert-butyl peroxy-2-ethylhexanoate in solution in 0.93 g of ethyl acetate were added and the mixture obtained was stirred for 5 minutes. The feeds below were metered into their polymerization vessel at an internal temperature of 80° C., beginning simultaneously, with stirring, and continuously, with constant volume flow rates:
Feed I: monomer mixture consisting of 50 g of vinyl acetate, 150 g of N-vinylcaprolactam, and 15 g of ethyl acetate, metered in over the course of 6 hours,
Feed II: 167 g of deionized water, metered in over the course of 6 hours, and
Feed III: 3.18 g of tert-butyl peroxy-2-ethylhexanoate in solution in 43.1 g of ethyl acetate, metered in over the course of 6.5 hours.

After the end of feed III 2 g of tert-butyl peroxy-2-ethylhexanoate in solution in 20 g of ethyl acetate were added and polymerization was continued at 80° C. for 1 hour. Thereafter the ethyl acetate was removed by distillation (temperature: 80 to 92° C., pressure: atmospheric pressure, time: approximately 1 hour). Residual amounts of ethyl acetate were removed by steam distillation (temperature: 92 to >100° C. internal temperature, steam pressure: 5 bar, time: approximately 1 hour; distillate volume: approximately 1000 ml). Subsequently a solids content of 43.7% by weight was set using deionized water. The solution obtained was milky white. It had a viscosity of 8800 mPas. The viscosity of a 40% strength by weight aqueous solution was 5350 mPas. The K value of the graft polymer was 26.3. The residual N-vinylcaprolactam content was <50 ppm.

### Graft Polymer C2

### Comparative Example 2

A polymerization pressure vessel was charged under nitrogen with 300 g of polyethylene glycol at atmospheric pressure and this initial charge was heated at 80° C. until all the polyethylene glycol had melted. Subsequently, with stirring, 70 mg of tert-butyl peroxy-2-ethylhexanoate in solution in 0.93 g of ethyl acetate were added and the mixture obtained was stirred for 5 minutes. The feeds below were metered into the polymerization vessel at an internal temperature of 80° C., beginning simultaneously, with stirring, and continuously, with constant volume flow rates:
Feed I: 50 g of vinyl acetate, metered in over the course of 1 hour,
Feed II: solution of 150 g of N-vinylcaprolactam and 15 g of ethyl acetate, metered in over the course of 3 hours, and
Feed III: 3.18 g of tert-butyl peroxy-2-ethylhexanoate in solution in 43.1 g of ethyl acetate, metered in over the course of 4.5 hours.

Feeds I and III were commenced simultaneously. Feed II was commenced after the end of feed I. After the end of feed III 2 g of tert-butyl peroxy-2-ethylhexanoate in solution in 20 g of ethyl acetate were added and polymerization was continued at 80° C. for 1 hour. Thereafter the ethyl acetate was removed by distillation (temperature: 80 to 92° C., pressure: atmospheric pressure, time: approximately 1 hour). Residual amounts of ethyl acetate were removed by steam distillation (temperature: 92 to >100° C. internal temperature, steam pressure: 5 bar, time: approximately 1 hour; distillate volume: approximately 1000 ml). Subsequently a solids content of 50.0% by weight was set using deionized water. The solution obtained was yellow and turbid (opaque from a thickness of about 3 cm). It had a viscosity of 1020 mPas. The viscosity of a 40% strength by weight aqueous solution was 230 mPas. The K value of the graft polymer was 26.7. The residual N-vinylcaprolactam content was <50 ppm.

### Graft Polymer C3

### Comparative Example 3

Graft polymer C3 was prepared in the same way as for graft polymer C2, with the difference that feed II was metered in before feed I.

After the steam distillation a solids content of 49.3% by weight was set using deionized water. The solution obtained was yellow and turbid (opaque at a thickness of about 3 cm). It had a viscosity of 1360 mPas. The viscosity of a 40% strength by weight aqueous solution was 290 mPas. The K value of the graft polymer was 27.3. The residual N-vinylcaprolactam content was <50 ppm.

### Graft polymer C4

### Comparative Example 4 in Accordance with Example 1 of DE 199 35 063 A1

A polymerization vessel with reflux condenser was charged under nitrogen with 300 g of polyethylene glycol at atmospheric pressure and this initial charge was heated, by means of an oil-bath temperature-controlled at 100° C., until all of the polyethylene glycol had melted. Subsequently 0.4. g of tert-butyl peroxy-2-ethylhexanoate in 3 g of methanol was added and the mixture was stirred for 5 minutes. The feeds below were metered into the polymerization vessel at an oil-bath temperature of 100° C., with stirring, continuously, and with constant volume flow rates:
Feed I: monomer mixture consisting of 60 g of vinyl acetate and 240 g of N-vinylcaprolactam, metered in over the course of 5 hours
Feed II: 3.6 g of tert-butyl peroxy-2-ethylhexanoate in solution in 27 g of methanol, metered in over the course of 5 hours.
Feeds I and II were commenced simultaneously. After the end of the feeds polymerization was continued for 3 hours. Subsequently 900 g of water were added over 30 minutes. The solids content was 35.9% by weight. The solution obtained was slightly yellowish and very turbid (opaque at a thickness of about 3 cm). It had a viscosity of 160 mPas. The K value of the graft polymer was 27.9. The residual N-vinylcaprolactam content was 1928 ppm.

### Investigations of Gas Hydrate Inhibition

From the aqueous solutions of above-described graft polymers P1, P2 and also C1 to C4, dilution with deionized water was carried out in order to prepare a dilute solution comprising 4500 ppm of graft polymer. 120 ml of a thus-diluted solution were introduced into a clean dry 300 ml steel autoclave. Throughout the test the solution was stirred at 500 revolutions per minute (electronically controlled stirring motor) with a Teflon-clad stirrer. The gas space over the aqueous solution was flushed at room temperature for approximately 1 minute with Mungo-2 gas (available commercially from Praxair GmbH; for composition see Table 1). Subsequently the solution was cooled to 4° C. in an atmosphere of Mungo-2 gas at atmospheric pressure. Thereafter Mungo-2 gas was injected up to a pressure of 30 bar (overpressure), and after 10 minutes the internal pressure was adjusted again to 30 bar—this is done in order largely to compensate a pressure drop caused by the gas dissolving in the cold solution under 30 bar pressure. Thereafter the autoclave was closed completely and, with a constant internal temperature and continuous stirring, the internal pressure was measured continuously. The inhibition time was evaluated as the period of time after which the internal pressure had dropped to ≦29 bar. The time periods obtained for the corresponding tests are reported in Table 2. The longer this time period, the better the gas hydrate inhibitor activity of the tests graft polymer.

In order to prevent leaks from the steel autoclave the measurements were continued, even after the internal pressure had fallen below 29 bar, until the internal pressure attained a constant value again, over 3 hours. This ensured that the autoclave was gastight in each case and that the pressure drop observed was brought about as a result of the formation of gas hydrates. The tests were discontinued after a maximum of 288 hours.

TABLE 1
Composition of Mungo-2 gas

| Components | mol % | Components | mol % |
|---|---|---|---|
| nitrogen | 1.75 | isobutane | 0.62 |
| carbon dioxide | 1.36 | n-butane | 1.12 |
| methane | 79.29 | isopentane | 0.2 |
| ethane | 10.84 | n-pentane | 0.19 |
| propane | 4.63 | | |

TABLE 2
Test results for the graft polymers described

| Graft polymer | Gas hydrate formation after × hours |
|---|---|
| P1 | 284 |
| P2 | >288 |
| C1 | <0.5 |
| C2 | 10 |
| C3 | 7 |
| C4 | 31 |

1. A process for preparing graft polymer by addition-polymerizing
A) 10% to 95% by weight of graft monomers A), comprising, based on the total amount of the graft monomers A),
a) 10% to 99% by weight of at least one vinyl ester [monomers a)],
b) 1% to 99% by weight of at least one N-vinyllactam. [monomers b)], and if appropriate
c) 0 to 10% by weight of at least one further ethylenically unsaturated monomer [monomers c)], the amounts of monomers a) to c) adding up to 100% by weight, in the presence of
B) 5% to 90% by weight of at least one polyalkylene oxide B) composed of at least 3 units of a C2 to C4 alkylene oxide, the total amounts of graft monomers A) and polyalkylene oxide B) adding up to 1100% by weight,
wherein
i) ≧50% by weight of the total amount of polyalkylene oxide B) and ≦10% by weight of the total amount of graft monomers A) are charged to a reaction vessel, then
ii) any remainder of polyalkylene oxide B) and also ≧90% by weight of the total amount of graft monomers A) are metered into the reaction vessel under polymerization conditions, with
iii) the major amounts of monomers a) and of monomers b) being metered in parallel in step ii),
iv) the polymerization takes place in the presence of ≧2% by weight, based on the sum of the total amounts of graft monomers A) and polyalkylene oxide B), of at least one aprotic organic solvent L), if appropriate a partial amount or the total amount of the solvent L) being introduced as an initial charge in the reaction vessel in step i) and the total amount or any remainder of the solvent L) being metered into the reaction vessel in step ii), and
v) the water content of the polymerization mixture present, in the reaction vessel during the polymerization at any time being ≦2% by weight, based on the sum of the total amounts of graft monomers A) and polyalkylene oxide B) metered into the reaction vessel at that time.

2. The process according to claim 1, wherein the polymerization is initiated by addition of free-radical initiators.

3. The process according to claim 1, wherein 20% to 75% by weight of graft monomers A), comprising
a) 10% to 70% by weight of monomers a) and
b) 30% to 90% by weight of monomers b),
and
25% to 80% by weight of polyalkylene oxide B)
are used.

4. The process according to claim 1, wherein monomers a) used are vinyl acetate, vinyl propionate, vinyl butanoate, vinyl hexanoate and/or vinyl octanoate and monomers b) used are N-vinyl-2-pyrrolidone, N-vinylcaprolactam and/or N-vinyl-2-piperidone.

5. The process according to claim 1, wherein the metered addition of the monomers a) and of the monomers b) in step ii) begins simultaneously and the metering time of the monomers b) is greater than or equal to the metering time of the monomers a).

6. The process according to claim 1, wherein the polyalkylene oxide B) has an average molecular weight in the range ≧300 and ≦35 000 g/ml.

7. The process according to claim 1, wherein the polyalkylene oxide B) is a polyethylene glycol.

8. The process according to claim 1, wherein the metered addition in step ii) takes place continuously.

9. The process according to claim 1, wherein water, a monohydric, dihydric or polyhydric alcohol and/or a corresponding monoalkoxy alcohol are/is added to the polymerization mixture after the end of the polymerization reaction.

10. The process according to claim 9, wherein the organic solvent L) is separated off before, during and/or after addition of water, alcohol and/or monoalkoxy alcohol.

11. A graft polymer obtainable by a process according to claim 1.

12. The method of inhibiting gas hydrates comprising dissolving a graft polymer according to claim 11.

13. The process according to claim 2, wherein 20% to 75% by weight of graft monomers A), comprising
a) 10% to 70% by weight of monomers a) and
b) 30% to 90% by weight of monomers b),
and
25% to 80% by weight of polyalkylene oxide B)
are used.

14. The process according to claim 2, wherein monomers a) used are vinyl acetate, vinyl propionate, vinyl butanoate, vinyl hexanoate and/or vinyl octanoate and monomers b) used are N-vinyl-2-pyrrolidone, N-vinylcaprolactam and/or N-vinyl-2-piperidone.

15. The process according to claim 3, wherein monomers a) used are vinyl acetate, vinyl propionate, vinyl butanoate, vinyl hexanoate and/or vinyl octanoate and monomers b) used are N-vinyl-2-pyrrolidone, N-vinylcaprolactam and/or N-vinyl-2-piperidone

16. The process according to claim 2, wherein the metered addition of the monomers a) and of the monomers b) in step ii) begins simultaneously and the metering time of the monomers b) is greater than or equal to the metering time of the monomers a).

17. The process according to claim 3, wherein the metered addition of the monomers a) and of the monomers b) in step ii) begins simultaneously and the metering time of the monomers b) is greater than or equal to the metering time of the monomers a).

18. The process according to claim 4, wherein the metered addition of the monomers a) and of the monomers b) in step ii) begins simultaneously and the metering time of the monomers b) is greater than or equal to the metering time of the monomers a).

19. The process according to claim 2, wherein the polyalkylene oxide B) has an average-molecular weight in the range ≧300 and ≦35 000 g/mol.

20. The process according to claim 3, wherein the polyalkylene oxide B) has an average molecular weight in the range ≧300 and ≦35 000 g/mol.
